(19) United States
(12) Patent Application Publication
(10) Pub. No.: US 2007/0034541 A1
(43) Pub. Date: Feb. 15, 2007

(54) Nuclear material container and methods of use

(75) Inventors: George Danko, Reno, NV (US); Piyush Kar, Reno, NV (US); Joseph Sam Armijo, Sparks, NV (US); Manoranjan Misra, Reno, NV (US); Davood Bahrami, Reno, NV (US)

Correspondence Address: KLARQUIST SPARKMAN, LLP, 121 SW SALMON STREET, SUITE 1600, PORTLAND, OR, 97204, US

(73) Assignee: Board of Regents of the University and College System of Nevada, Reno, NV (US)

(21) Appl. No.: 11/357,705

(22) Filed: Feb. 17, 2006

Related U.S. Application Data
(60) Provisional application No. 60/654,214, filed on Feb. 17, 2005.

(51) Int. Cl. G21F 9/00

(52) U.S. Cl. 206/524.1; 588/16

(57) ABSTRACT

The present disclosure provides a disposal container for nuclear materials. According to certain ambodiments, the disposal container includes a nuclear material sub-container of a first type and a plurality of nuclear material sub-containers of a second type. In particular implementations, the disposal container includes a plurality of nuclear material sub-containers of a first type. The nuclear material sub-containers of a second type may surround the nuclear material sub-container of a first type. In particular examples, the nuclear material sub-containers of a second type are arranged concentrically around the nuclear material sub-container of a first type. The disclosed disposal containers may provide more efficient storage of nuclear materials, such as nuclear waste.

### RELATED APPLICATION INFORMATION

The present application claims the benefit of U.S. Provisional Patent Application No. 60/654,214, filed Feb. 17, 2005, the disclosure of which is hereby incorporated by reference.

### BACKGROUND

High costs with nuclear waste disposal at the Yucca Mountain repository are typically attributed to the large number of disposal containers. Additionally, the risks associated with early container failure typically increase with as the number of containers increases. The current (also referred to as “License Application” or LA) containers (also referred to as “waste packages”) are typically designed with free spaces between individual nuclear material sub-containers (also referred to herein as assemblies, units, or canisters). The loosely packed container design, i.e. the LA design, often leads to significantly more containers.

### SUMMARY

Certain embodiments provide container designs that allow for more efficient storage of nuclear wastes. Some embodiments allow for the disposal of a plurality of different types of nuclear waste within the same container. In at least one embodiment, a waste container includes a central nuclear material sub-container of a first type surrounded, such as concentrically, by one or more nuclear material sub-containers of a second type. In a further embodiment, a nuclear material container includes a plurality of nuclear material sub-containers of a first type formed in a central nucleus and surrounded by one or more nuclear material sub-containers of a second type. By increasing the amount of nuclear material that may be stored in each container, the number of containers needed may be reduced. In addition, proper selection of the amount of each type of nuclear sub-container in the container can be used to adjust the amount of heat generated by each container, for example, to comply with regulatory guidelines.

For example, certain embodiments of the invention provide alternative container designs that would utilize the free space in the LA spent nuclear fuel (SNF) containers for holding additional nuclear wastes. At least some designs may reduce disposal costs and use the additional heat, due to more waste per container, for favorably engineering the emplacement drift thermal-hydrology.

Modification of the SNF, i.e. the pressurized water reactor (PWR) and the boiling water reactor (BWR), containers are proposed in order to accommodate additional wastes making more effective utilization of the waste package space. The additional wastes are the Department of Energy High Level Waste (DOE-HLW) canisters that are planned in the LA design for disposal within the 6 canister over-pack containers (referred to as 5 DOE-HLW/1 DOE-SNF containers). Due to the similar characteristics in the commercial waste (BWR and PWR assemblies) and the DOE-HLW forms, both may be placed together into one waste container.

Two new designs are proposed for both the PWR and the BWR waste packages. The proposed design configurations would make more effective use of the available waste package volume, at least substantially eliminating the gap in the waste packages to accommodate colder DOE-HLW canisters. At least certain embodiments incorporate DOE-HLW canisters within the BWR and PWR containers. The proposed new designs are also subsequently referred to as co-disposal waste package designs. The designs adhere to the current federal regulatory standards.

The new designs may decrease the number of DOE-HLW packages and may eliminate the necessity of, or the number of, current DOE-HLW containers. As a result there may be a decrease in the waste disposal cost and due better engineering of the emplacement drift. Incorporations of these new designs may eliminate the necessity of, or reduce the number of, the 5 DOE-HLW/1 SNF waste packages by implementation of one design and may decrease the number of the DOE-HLW canisters to be disposed by more than half of the current number of canisters by implementation of the other design.

The present disclosure also provides method for using the disclosed containers. For example, the disclosed containers can be used in an emplacement drift.

There are additional features and advantages of the various embodiments of the present invention. They will become evident as this specification proceeds.

In this regard, it is to be understood that this is a brief summary of the various embodiments described herein. Any given embodiment of the present invention need not provide all features noted above, nor must it solve all problems or address all issues in the prior art noted above.

### BRIEF DESCRIPTION OF THE DRAWINGS

FIG. 1. Cross-sectional schematic of the current BWR waste package design in the License Application, i.e. the 44 BWR waste package, showing the unused volume. Dimensions are in cm and are as shown in the figure (figure not to scale).

FIG. 2. Cross-sectional view of the proposed co-disposal 44 BWR/1 DOE HLW waste package design, the circle in the center represents the DOE-HLW canister and the squares arranged in the radial configuration represent the BWR assemblies (44 of those). The package incorporates a DOE HLW canister of enlarged diameter from 61 cm to 80 cm. There is no change in the waste package dimension for accommodating the canister and the SNF assemblies. Dimensions are in cm and are as shown in the figure (figure not to scale).

FIG. 3. Cross-sectional schematic of the current PWR design in the License Application, i.e. the 21 PWR waste package, showing the unused volume. Dimensions are in cm and are as shown in the figure (figure not to scale).

FIG. 4. Cross-sectional view of the proposed co-disposal 24 PWR/DOE HLW waste package design, the circle in the center represents the DOE-HLW canister and the squares arranged in the radial configuration represent the PWR assemblies (24 of those). The package incorporates a DOE HLW canister of the same diameter as in the License application design, i.e. 60 cm. There is 5 cm increase in the waste package outer diameter to accommodate the canister and the SNF assemblies. Dimensions are in cm and are as shown in the figure (figure not to scale).

FIG. 5. Cross-sectional view of another proposed co-disposal 55 BWR/3 DOE HLW waste package design, the circles in the center represent the DOE-HLW canisters and the squares arranged in the radial configuration represent the BWR assemblies (55 of those). The package incorporates three DOE-HLW canisters of the same size as the License Application design. There is an increase in the overall waste package dimensions to accommodate the HLW wastes and the SNF assemblies. Dimensions are in cm and are as shown in the figure (figure not to scale).

FIG. 6. Cross-sectional view of another proposed co-disposal 18 PWR/3 DOE HLW waste package design. The circles in the center represent the DOE-HLW canister and the squares, arranged in the radial configuration, represent the PWR assemblies (18 of those). The package incorporates three DOE HLW canister of the same diameter as in the License Application design, i.e. 61 cm. There is an overall increase in the waste package diameter to accommodate the canisters and the SNF assemblies. Dimensions are in cm and are as shown in the figure (figure not to scale).

FIG. 7. Schematic of waste package arrangement in the emplacement drift. (a.) License Application design—none of the DOE-HLW canisters accommodated in the SNF packages, (b.) SNF packages with 1 DOE-HLW canisters—half of the of DOE-HLW canisters accommodated in the SNF packages, and (c.) SNF packages with 3 DOE-HLW canisters—complete accommodation of DOE-HLW canisters in the SNF packages. Figure not to scale.

FIG. 8. Cross-sectional schematic of the proposed 52 BWR waste package

FIG. 9. Discretization scheme of an enlarged waste package (i.e. 52 BWR) cross-section. Numbers represent the elements, and are connected in the “x” and “y” directions as well as the “diagonal” directions (shown in FIG. 10).

FIG. 10. (a.) Schematic of the heat flow network connections for the waste package interior nodes (i.e. the nodes inside the waste package basket). The nodes “1”, “ ” “n” and “o” are the basket tube nodes and “k” is an assembly node. The lines denote the connection directions, i.e. “x”, “y” and “diagonal”. (b.) Schematic showing the details of a diagonal connection, a diagonal connection is applicable only to the waste package basket nodes, the connection forms a right angled triangle with its path (broken into two lines at right angles to each other).

FIG. 11. Cross-sectional schematic of the BWR assembly with a typical 8×8 matrix of fuel rods. The fuel rods, represented as shaded circles, are considered to be inside an imaginary line that separates the edge region from the interior region.

FIG. 12. Geometry of (a.) geometry resembling rectangular domains resembling those that govern waste package heat transfer (here, the dimensions “a”, “b” and “c” are such that b>>a and b>>c), and (b.) wedge-type geometry for the perpendicular plate configuration for the radiative view factor calculations (here, the dimensions “l”, “h” and “w” are such that 1>>h and 1>>w). Indices 1, 2 and 3, of figures (a.) and (b.), are used to denote the surfaces involved in the heat transfer connections.

FIG. 13. Plots of the waste package component nodes' temperature distribution at the various instants of emplacement—60, 1000 and 5000 years. Temperature of the CORTEN surface (i.e. surface of the waste package container) can be observed to remain above 100° C. for the first thousand years after emplacement. Also, the assembly temperatures doesn't exceed regulatory standard of 350° C.

FIG. 14. Plot of thermal conductivity values of the BWR assemblies at the various instants after emplacement—60, 1000 and 5000 years. It can be observed that the thermal conductivity is the lowest after 5000 years when the drift air temperature is the lowest and highest after the pre-closure period (i.e. 60 years) when the drift air temperature is the highest.

FIG. 15. Plot of temperatures of five representative points of the waste package with respect to time, at (a.) fixed thermal conductivity of 0.6 W/m-K, and (b.) temperature dependent variable thermal conductivities. For both the cases, temperature of the CORTEN surface can be observed to remain above 100° C. for a few thousand years after emplacement and the assembly temperatures doesn't exceed regulatory standard of 350° C.

FIG. 16. Surface temperature variation of the hottest and coldest waste packages with time.

### DETAILED DESCRIPTION

In order to facilitate review of the various embodiments of the disclosure, the following explanations of specific abbreviations and terms are provided:

BWR—boiling water reactor

DOE—United States Department of Energy

PWR—pressurized water reactor

HLW—high1 level waste

SNF—spent nuclear fuel

LA—license application

SS—stainless steel

NRC—Nuclear Regulatory Commission

The disclosure proceeds with reference to certain specific embodiments of nuclear material containers according to the present disclosure. It to be understood that these embodiments are only exemplary and do not limit the scope of the disclosure. The containers contain a number of sub-containers, the exact number, nature, and position of which can be varied.

44 BWR/1 DOE-HLW and 24 PWR/1 DOE-HLW Waste Containers

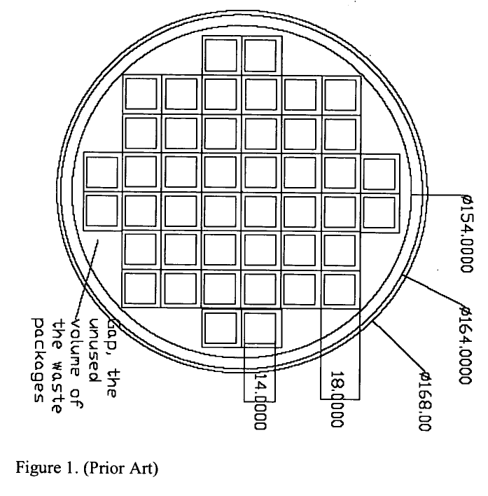

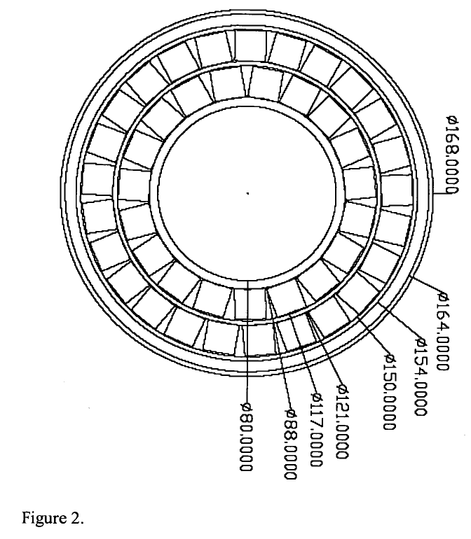

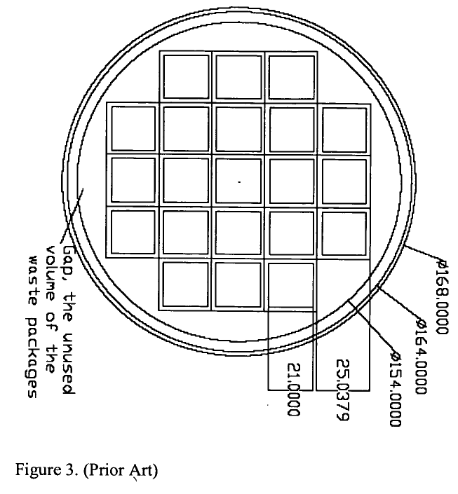

This design accommodates the commercial SNF assemblies and a DOE-HLW in the packages together in one waste package. The design is modification of the License Application design (cross-sectional schematic shown in FIGS. 1 and 3 for BWR and PWR SNF respectively), utilizing the space in between basket in the inner shell, for holding HLW wastes. The co-disposal 44 BWR/1 DOE-HLW waste packages accommodate an enlarged DOE HLW canister. The DOE-HLW canister diameter was increased from 0.61 m to 0.80 m, without increasing the overall waste package volume, and accommodating 44 BWR assemblies, FIG. 2 shows the cross-sectional schematic.

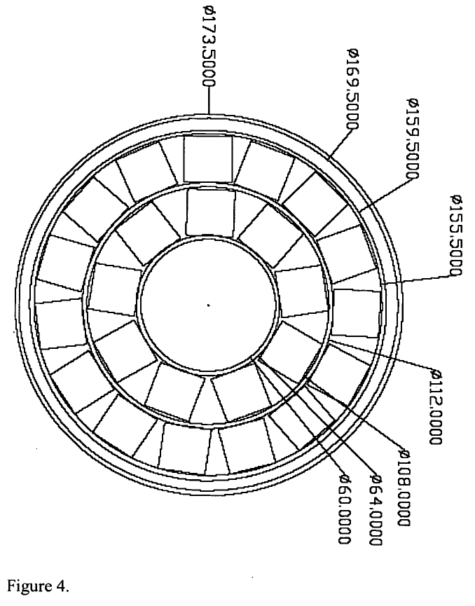

The co-disposal 24 PWR/1 DOE-HLW package (FIG. 4) is similar in design configuration as the BWR package. However, the 24 PWR waste packages accommodate a DOE HLW canister, of the same volume as the license application design. The other features unique to the 24 PWR/1 DOE-HLW design are increase in the waste package outer diameter by 5 cm from the License Application design and accommodating 24 PWR assemblies (as compared to 21 assemblies in the License Application design).

The DOE-HLW/SNF canisters in the co-disposal BWR packages are confined by 4 cm thick stainless steel (SS) layers and those in the co-disposal PWR packages are confined by a 2 cm thick SS layer. The assemblies surround the cylinders in a radial manner enclosed in basket made of partly Neutronit for neutron shielding and partly Aluminum for structural strength and effective heat transport.

55 BWR/3 DOE-HLW and 18 PWR/3 DOE-HLW Waste Packages

This new design accommodates the commercial SNF assemblies and the DOE-HLW canisters in single packages. This design is generally similar in concept to the design mentioned above (i.e. in part 1.), however, with at least one difference. The at least one difference is made towards accommodating more waste per package at an overall increase in the waste volume.

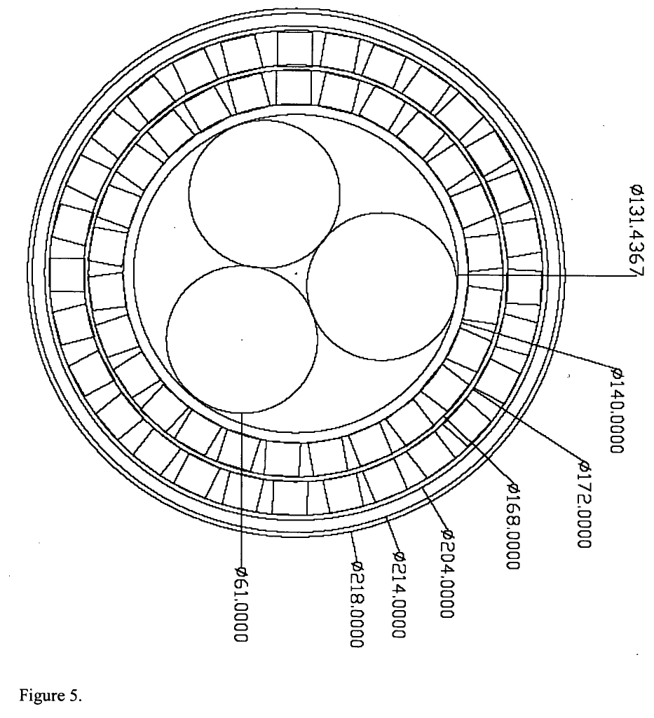

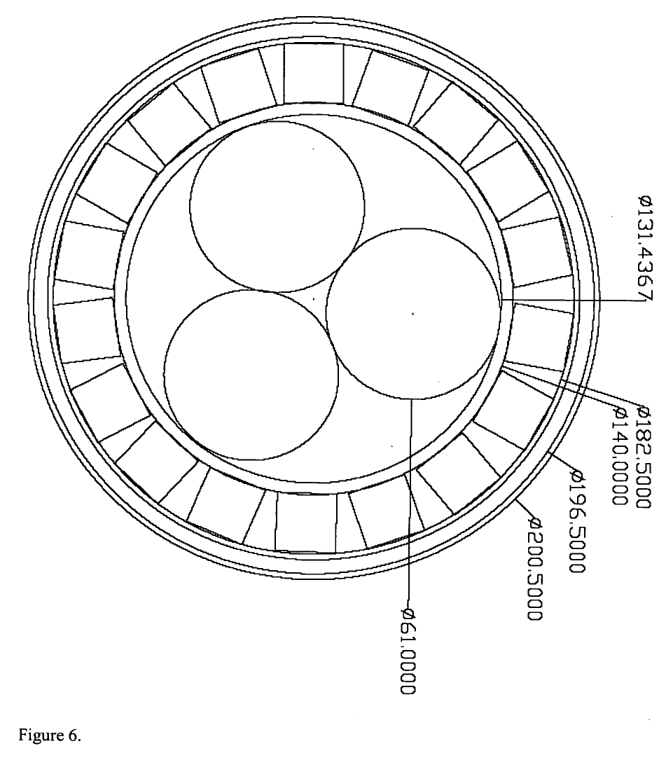

The co-disposal 55 BWR/3 DOE-HLW waste packages, as shown in FIG. 5, accommodate 55 BWR assemblies and 3 DOE-HLW canisters. The outer diameter of the co-disposal BWR package is 2.18 m. The co-disposal 18 PWR/3 DOE-HLW waste packages, as shown in FIG. 6, accommodate 18 PWR assemblies and 3 DOE-HLW canisters. The DOW-HLW canister sizes remain the same as in the License Application design. The 3 DOE-HLW canisters in both the BWR and PWR packages are confined by 4 cm thick SS layer. The SNF assemblies are arranged in a radial manner surrounding the HLW canisters in baskets made of partly Neutronit for neutron shielding and partly Aluminum for structural strength and effective heat transport.

Confirmation of the Co-Disposal Containers to Safety Requirements

The radionuclides containment in the co-disposal packages are as safe as those of the license application (LA) design. The SNF assemblies are contained in the neutron shield basket, though the geometry of the same is being varied to make more effective utilization of the available waste package interior volume. The current Nuclear Regulatory Commission (NRC) safety criterion requires the HLW and the SNF temperatures to be below 350° C. Additionally, according to present NRC criteria, the HLW waste temperatures must not go beyond 400° C., which is nearly the glass transition temperature of the HLW waste glass. Based on the waste package internal geometry, effective heat transport can be achieved from the waste package interior to it exterior by using aluminum shunts that would maintain the waste form in safe thermal limits.

Advantages of the Co-Disposal Containers

The proposed designs may yield lesser number of waste packages. The primary design advantages are potential cost savings in terms of the associated packaging materials, fabrication, transportation, and handling costs. The effective utilization of the waste package space would keep the waste package wall (or outer shell) hot which would delay condensation of water on the surface and may significantly reduce the required number waste packages.

The 44 BWR/1 DOE-HLW waste package design and the 24 PWR/1 DOE-HLW waste package designs may eliminate the need for half of the 5 DOE-HLW/1 DOE-SNF, as shown in Table 1. A feature of this design is the potential generation of waste disposal cost savings and the possibility of more favorable drift thermal-hydrology without significantly changing the waste package dimensions and the associated materials, fabrication, transportation and handling costs.

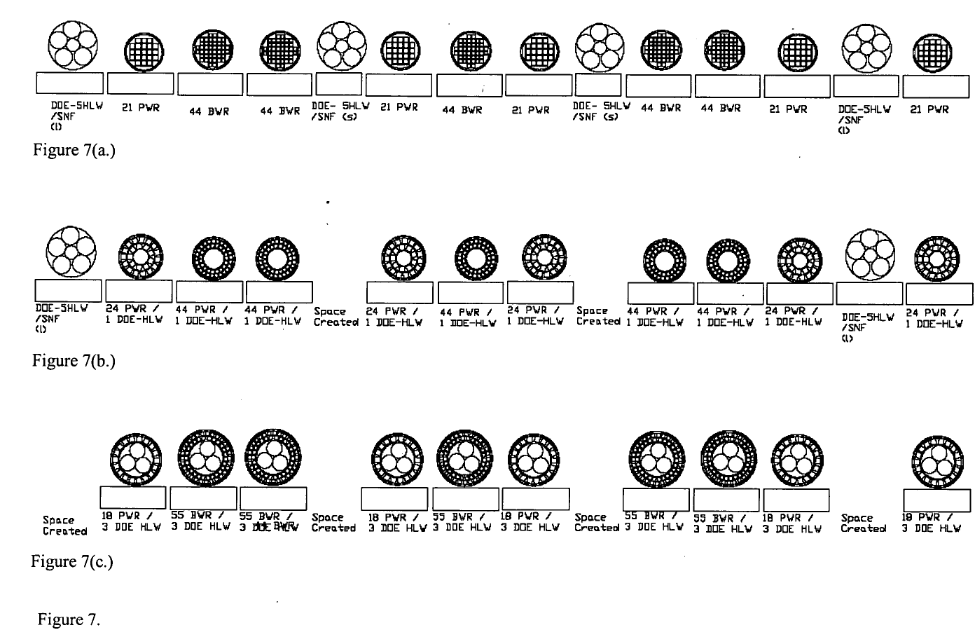

The 55 BWR/3 DOE-HLW and 18 PWR/3 DOE-HLW waste package dimensions are suggested, taking into the DOE-HLW inventory, for eliminating or reducing the necessity of the 5 DOE-HLW/1 DOE-SNF packages. A drift arrangement corresponding to the proposed waste package design is shown in FIG. 7(c.). It shows that none of the 5 DOE-HLW/1 DOE-SNF packages are necessary and space can be created. The created space could enable better engineering the arrangement of the remaining waste packages in the drift for more favorable thermal-hydrologic conditions for the remaining waste packages, in addition to generating a significant nuclear waste disposal cost saving.

### EXAMPLE

Thermal Design of an 52 BWR Waste Package

A 52 BWR waste package thermal modeling methodology is described below, demonstrating that the additional heat, due to the more waste in the container, can be effectively transported out of the container. The effective heat transport sustains the spent fuel in safe temperature range. A similar methodology can be applied for modeling the proposed co-disposal containers.

Description of the 52 BWR Waste Package Design

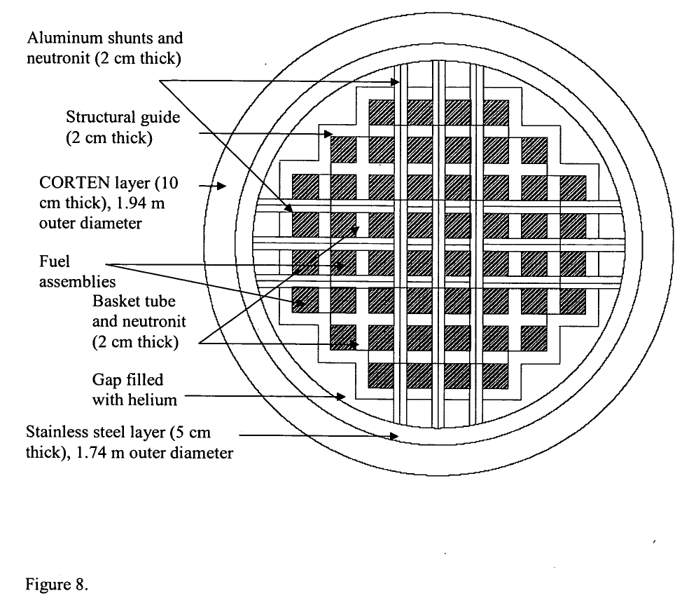

The cross-sectional geometry of the BWR spent fuel cask is shown in FIG. 8. Fuel assemblies, shown in the figure as shaded squares, are considered as homogenous heat generating solids with effective thermal conductivities. The basket consists of the structural guide and the basket tubes. The basket tubes are partly carbon steel and neutronit (a boronated stainless steel) and partly aluminum and neutronit. The carbon steel and neutronit layers have a 2 cm thickness of which two 0.75 cm layers of carbon steels sandwich a 0.5 cm thick layer of neutronit. These square tubes encapsulate the spent fuel assemblies, in effect serving as a neutron shield and also as a channel for conduction of heat to the aluminum shunts.

The aluminum shunts are the other part of the basket tube. These are shown in FIG. 8 as triple lined structures between adjacent assemblies. These are also 2 cm thick, having a 0.5 cm layer of neutronit sandwiched between two 0.75 cm thick layers of aluminum. The aluminum shunts are extended to contact the waste package inner wall, i.e. the inner surface of the stainless steel cylinder. These aluminum shunts are included in the design for increasing the heat conduction from the spent fuel assemblies to the waste package wall. The structural guide as shown in the figure is the outermost part of the basket; it is made of carbon steel and has a thickness of 2 cm. The heat flow from the assemblies to the basket grid is primarily conduction. A gap exists in between the basket (i.e. adjacent to the structural guide) and the inner wall of the cylinder. This gap is backfilled with pressurized helium. The heat transfer in this gap is characterized by convection treated as conduction with an increased effective conductivity and radiation [Shibazaki et al (1998)]. The waste package component next to the gap is the 5 cm thick stainless steel, as in the existing design of the 44 BWR waste packages. The next and the outermost layer is the 10 cm thick CORTEN steel. The heat transfer across the stainless steel and the CORTEN layers is radial conduction.

Thermal Model of 52 BWR Waste Package

The three dimensional heat transfer mechanism in the waste package is complex. The heat flow problem in the radial direction (i.e. in one cross-section) of the waste package is modeled on the millimeter scale from the heat generating fuel-rods to the outer surface of the waste package. The axial heat flow is modeled as a separate task, incorporated in the three-dimensional emplacement drift-scale thermal model, providing outer surface temperature distribution as boundary condition for the radial flow waste package model. This axial heat flow model is a centimeter-scale emplacement drift thermal model accounting for the neighboring-effects of the various waste containers with different heat dissipation, the ultimate reason for having axial temperature variation and heat flow along the drift. The procedure adapted is the heat flow network method that can be implemented using MULTIFLUX [Danko (2000), incorporated by reference herein].

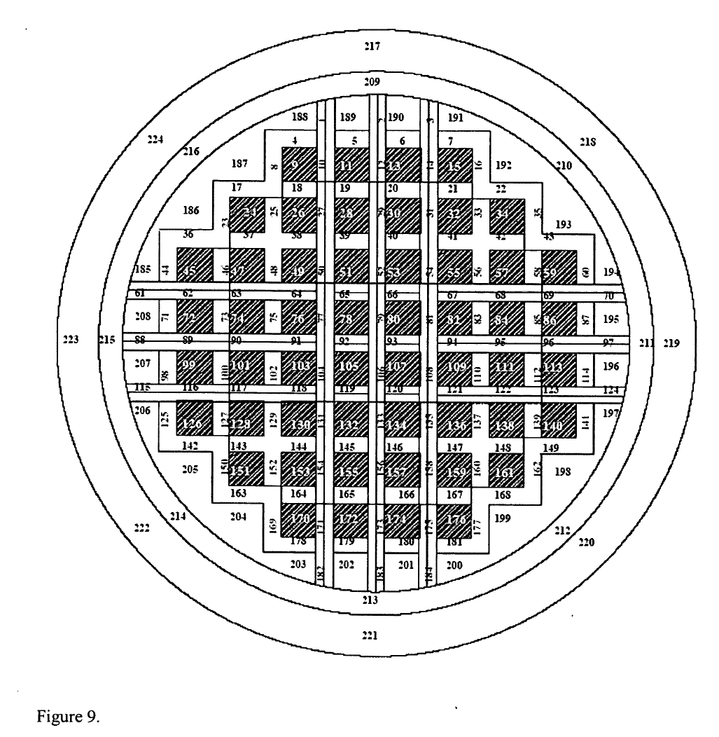

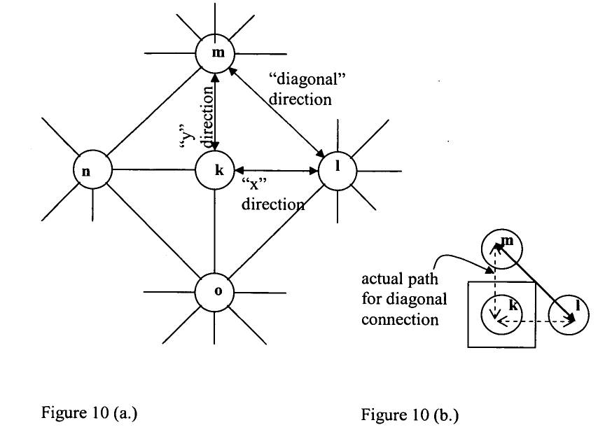

The waste package cross-section is descretized as shown in FIGS. 9 and 10. There are a total of 224 nodes in the cross-section. The nodes are of variable sizes depending on their type and position in the cross-section. The different types of the nodes are passive solid nodes, fluid nodes (those of helium in the gap between the basket and the inner cylinder) and heat generating solid nodes (the assembly nodes).

The heat flow network allows connections between a node to other desired nodes. MULTIFLUX calculates the thermal admittance of each connection. The admittances for the connections for all the nodes are processed as coefficients in a network matrix representing heat balance equations for the entire model domain. The solution of the model provides the temperature distribution. The model outputs the steady state temperature distribution at a given boundary condition. The boundary condition in this case is the time-dependent waste package surface temperature from the thermal and moisture flow model constituted for an entire emplacement drift in an emplacement tunnel at Yucca Mountain. The description of this waste package exterior thermal and moisture flow model is described in detail in another paper [Barhami & Danko, (2005), incorporated by reference herein]. The thermal model within the waste package is described with the following constitutive equations (1) to (3) for all connections:

For conduction,

$${q}_{ij} = {A}_{ij} {K}_{ij} \frac{( {T}_{i} - {T}_{j} )}{{δ}_{ij}} \qquad ( 1 )$$

For radiation,
qᵢⱼ=AᵢⱼBεᵢⱼφᵢⱼ(Tᵢ⁴−Tⱼ⁴) (2)

For convection,
qᵢⱼ=Aᵢⱼhᵢⱼ(Tᵢ−Tⱼ) (3)

The heat balance equation for a node is given by:
Σq=0 (4)

Calculation of Assembly Thermal Conductivity with Helium

The interior heat transfer in the assembly is a complex phenomenon because of its anisotropic structure. The BWR assembly is a square enclosure having a 14 cm×14 cm cross-section and 4.5 meter (m) length. Within its cross-section there is an 8×8 fuel rod matrix consisting of 62 fuel rods and 2 moderator rods. The fuel rods consist of the UO₂ fuel pellets, a very thin gap (in between the pellet and the cladding) filled with pressurized helium and fission product gases, and the zircaloy-2 cladding.

The fuel rods are arranged inside the assembly as non-touching-cylinders, kept in place by distant-keepers. Outside the fuel rods is the backfill media (pressurized helium in case of the BWR assemblies). More than one mode of heat transfer is usually prevalent. The kind of backfill media and the backfill pressure markedly affects the heat transfer mode and the fuel-assembly wall temperature difference [Manteufel & Todreas (1993) and Canaan & Klein (1996)].

Experimental and modeling results have consistently demonstrated that very little or no natural convection occurs within the assemblies with helium as backfill gas. Natural convection occurs due to buoyancy driven fluid flow when the Raleigh Number exceeds its critical value. Experimental studies [Keyhani et al (1987), Gotovsky et al (1986) and Vdovets et al (1986)] have concluded that the critical Raleigh Number cannot be reached in the applicable transportation and storage conditions (i.e. temperature and pressures) for the assemblies with helium backfill. The dominant modes of heat transfer with helium backfill under pressurization in the range of 0-5 atmospheres are conduction and radiation [Manteufel and Todreas (1993), Canaan & Klein (1996)].

The effective thermal conductivity of the waste package assemblies includes temperature-dependent thermal radiation and therefore it requires numerical modeling. The assembly heat transfer phenomena has been studied [Canaan & Klein (1996), Manteufel and Todreas (1992) & (1993), Keyhani & Luo (1994) and Kelkar & Patankar (1990)] for an accurate estimation of the effective thermal conductivity. Manteufel and Todreas (1993) developed analytical formulae for their continuum and lumped K_{eff}/H_{edge} models for determination of assembly effective thermal conductivity. Both of these models predict very nearly equal values for the BWR assembly thermal conductivity, and therefore they confirm each other's validity. The continuum K_{eff}/H_{edge} model is used in this Example for calculating the BWR assembly effective thermal conductivity.

Description of the Continuum K_{eff}/H_{edge} Model for Determination of the BWR Assemblies' Effective Thermal Conductivities

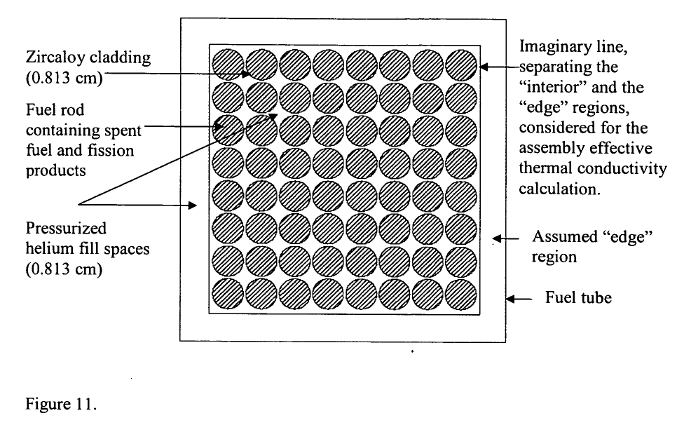

The assembly is assumed to have two distinct regions, i.e. an interior region containing all the fuel rods and an exterior region surrounding and encapsulating the interior region, called the wall (FIG. 11). The assembly interior heat transfer is modeled by the effective thermal conductivity, Kₐᵢ, while the assembly exterior heat transfer is modeled by a heat transfer coefficient, Hₐₑ. The overall assembly effective conductivity is finally obtained by evaluating the thermal resistances due to the interior and the exterior regions. The heat transfer includes thermal radiation and therefore the overall effective thermal conductivity is temperature dependent. The appropriate assembly temperature is obtained by an iterative computation assuming a realistic guessed value for the temperature in the first step. Since assemblies at different locations in the waste package basket would attain temperatures typical to their location, the assembly effective thermal conductivity for each assembly is determined as unique.

The assembly interior effective conductivity, Kₐᵢ, is given by equation (5) [Manteuffel & Todreas (1993)]. The first term to the right of the equation expresses the interior conduction in the fuel rods comprising the weighted average of the UO₂ pellets, zircaloy cladding and helium fill. The second term on the right represents thermal radiation.
Kₐᵢ=F_{cond}K_{gas}+C_{rad}Bπd4T³ (5)

The assembly edge heat transfer coefficient is given in equation (6). The first term in the right hand side is the wall conductive heat transfer coefficient and the second term is the wall radiative heat transfer coefficient. The values, F_{cond,w} (the wall conduction factor) and f (the edge to interior heat transfer ratio), are determined in the manner defined by Manteuffel & Todreas (1993), incorporated by reference herein:

$${H}_{ae} = \frac{{F}_{cond , w} {K}_{gas}}{( 1 - f / 2 ) w} + \frac{{C}_{rad , w , 2} B π d 4 {( T )}^{3}}{( 1 - f / 2 ) p} \qquad ( 6 )$$

The overall assembly effective conductivity can be determined from the resultant sum, R, of the thermal resistances, R1 and R2, representing the interior and edge regions respectively. The total resistance, R, is given by equation (7) and the effective thermal conductivity of the assembly, K_{assembly} is given by equation (8).

$$\begin{matrix}R = R 1 + R 2 = \frac{L}{{K}_{ai} A} + \frac{1}{{H}_{ae} A} & ( 7 ) \\ {K}_{assembly} = \frac{{L}_{assembly}}{RA} & ( 8 )\end{matrix}$$

Convective-Radiative Heat Transfer Across the Gap Between the Basket and the Waste Package Inner Cylinder

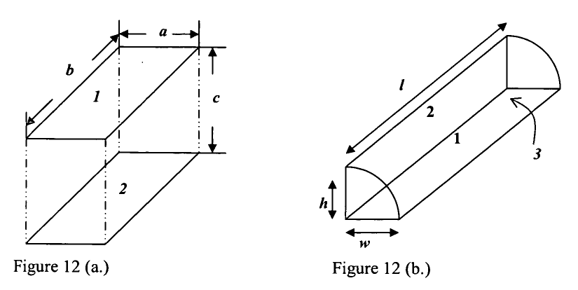

Heat transfer in the gap between the waste package and inner cylindrical walls of the waste containers is convective and radiative. The convective heat transfer is typical to that occurring in horizontal and vertical enclosures depending on the location of the gap. MULTIFLUX allows for modeling natural convection in enclosures. However, due to the low temperature differences in the gap, a simple heat conduction model is selected for the helium filled gap in the present study. The radiative heat transfer is modeled either as a rectangular-type or as wedge-type domain shown in FIGS. 12 (a) and (b). The geometry of the gap in most places (e.g. node 185 to 208 in FIG. 8) resembles two perpendicular plates joined by curved surface as shown in FIG. 12 (b). The configuration is used for calculating the radiative view factors between surfaces 1 and 2.

The radiative view factor is calculated using the formula [Handbook of Essential Formulae and Data on Heat Transfer for Engineers] given by equation (9) for radiation from plate 1 to 2 and that from plate 1 to 3 are determined by using view factor arithmetic, as given by equation (10).

$$\begin{matrix}{F}_{1 - 2} = \frac{1}{π W} \text{[} W {tan}^{- 1} \frac{1}{W} + H {tan}^{- 1} \frac{1}{H} - \sqrt{{H}^{2} + {W}^{2}} {tan}^{- 1} \frac{1}{\sqrt{{H}^{2} + {W}^{2}}} + \frac{1}{4} ln \{ {{\frac{( 1 + {W}^{2} ) ( 1 + {H}^{2} )}{1 + {W}^{2} + {H}^{2}} [ \frac{{W}^{2} ( 1 + {W}^{2} + {H}^{2} )}{( 1 + {W}^{2} ) ( {W}^{2} + {H}^{2} )} ]}^{{w}^{2}} [ \frac{{H}^{2} ( 1 + {H}^{2} + {W}^{2} )}{( 1 + {H}^{2} ) ( {H}^{2} + {W}^{2} )} ]}^{{H}^{2}} \} & ( 9 ) \\ {F}_{1 - 3} = 1 - {F}_{1 - 2} & ( 10 )\end{matrix}$$

Results

The thermal model with 224 nodes with convective, conductive and radiative thermal connections between them was configured in MULTIFLUX. The heat dissipation of the spent fuel was modeled as time-dependent heat source, directly applied to the fuel assembly nodes. The thermal model was solved for the hottest BWR package along the emplacement drift for 27 different time instants over the first 5000 years storage time period. For each time instant the solution was iterated until the temperature-dependent heat transport connections were calculated within 0.1° C. of the balanced temperature.

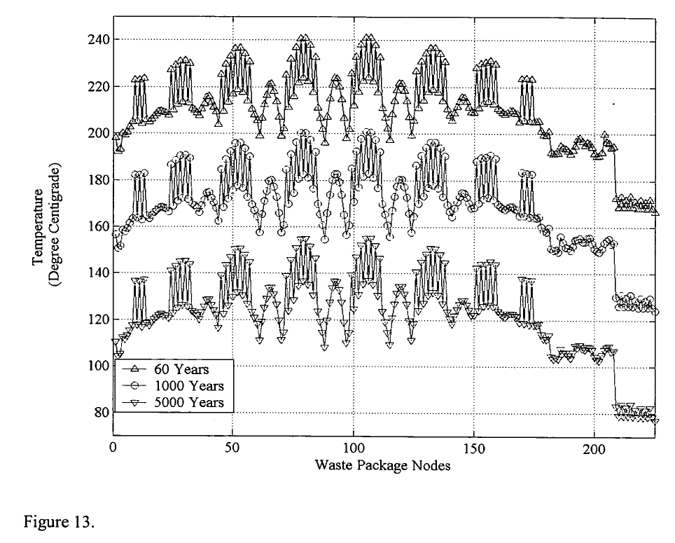

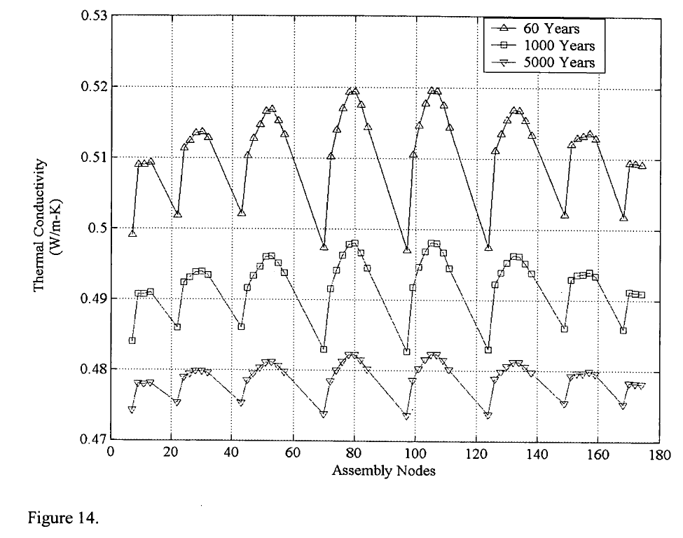

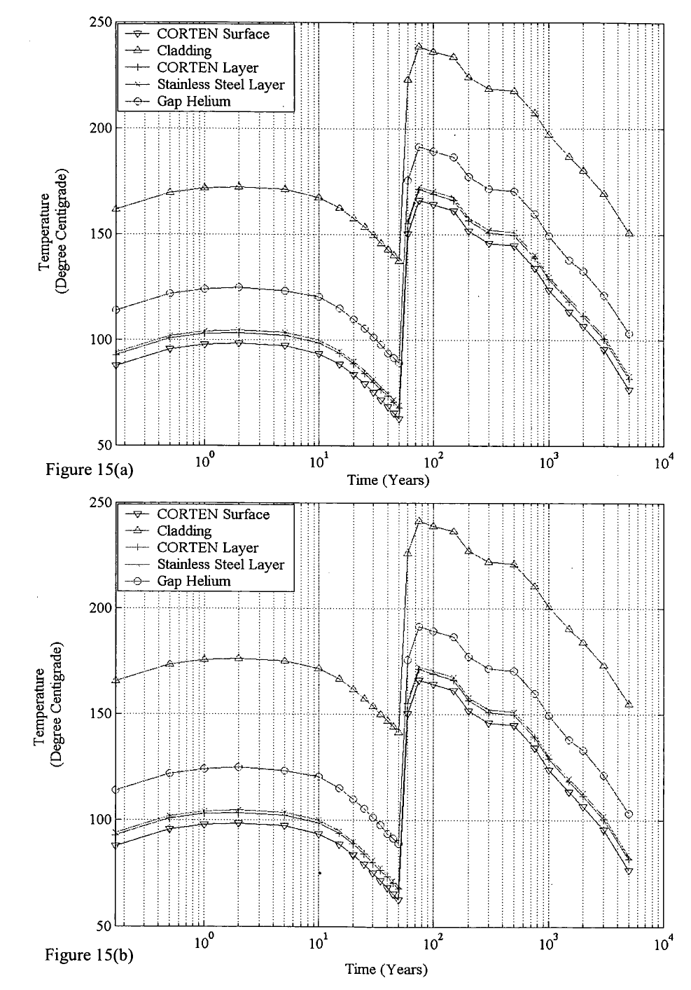

FIG. 13 shows the temperatures of the nodes in the hottest waste package at three time instants, i.e. 75, 1000 and 5000 years after emplacement. FIG. 14 is the plot of the effective thermal conductivity values at the three different times after emplacement. As shown, the effective thermal conductivity varies from place-to-place as well as with time due to variation in temperature. FIG. 15 depicts the temperatures of five representative points in the waste package as a function of time over the entire study time period.

The feasibility of the design in terms of maintaining the maximum waste package temperature, that of the spent fuel cladding, below 350° C. (the regulated NRC limit [CRWMS M&O 1998a]), has been demonstrated in the results. As can be seen from FIGS. 15 (a) and 15 (b) the maximum attained cladding temperature is about 240° C. The maximum temperature difference between the cladding and waste package outer surface is less than 100° C., a favorably low value in spite of the enlarged design with about 20% or more waste and corresponding heat load in it.

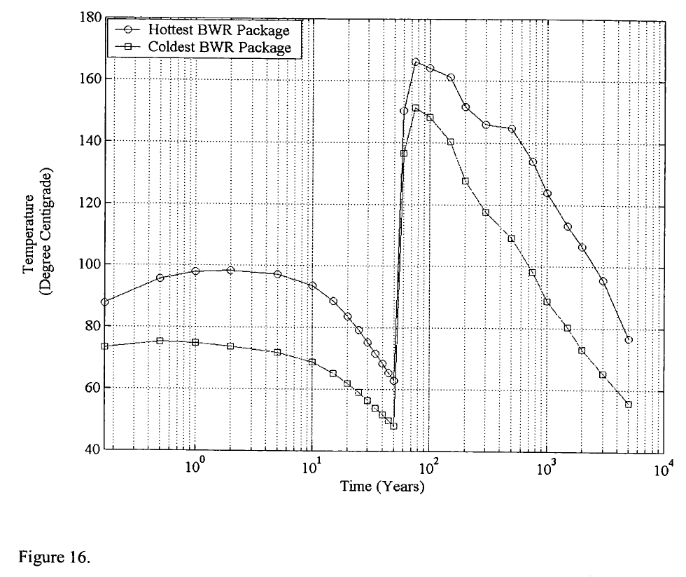

The assembly thermal conductivity is slightly temperature dependent, and as a result each assembly has a unique thermal conductivity depending on its relative position in the waste package cross-section. These steady state cross-sectional temperature variations range from 5 to 20° C. More variations in the temperature are caused by the changing boundary temperature with time which is shown in FIG. 16. The assembly temperatures (and hence the thermal conductivities) depend on heat transfer from the waste package which is dependent on the boundary temperatures among other factors. The thermal conductivity values range from 0.47 to 0.53 W/m-K, which is an arguably small interval to be considered a significant variation. Indeed, when the variable effective thermal conductivity is replaced with a constant value of 0.6 W/m-K, the temperature variation in the waste package remains nearly the same.

The temperature drop through the helium-filled gap is less than that occurring through the aluminum shunts. The effect of gap temperature drop can be observed in FIG. 12 (across nodes 185 to 209) and FIGS. 15 (a) and 15 (b). The maximum waste package temperature depends on the heat transport efficiency of the waste package interior. This efficiency depends on the effective thermal conductivities of the assemblies, the basket design and the fill material of the gap. In this analysis, the heat transfer is quite effective due to using aluminum shunts in the basket grid and backfilling helium in the gap. The heat transfer from the interior of the assemblies to the waste package exterior wall is very efficient and may allow for further optimization.

It is to be understood that the foregoing is a detailed description of certain embodiments. The scope of the present invention is not to be limited thereby and is to be measured by the claims, which shall embrace appropriate equivalents.

Nomenclature

q—heat flux [W]

qᵢⱼ—net heat transfer between any two nodes, “i” and “j” [W]

Tᵢ—temperature of the node, “i” [K or ° C.]

Tⱼ—temperature of the node, “j” [K or ° C.]

δᵢⱼ—effective heat flow distance between any two nodes, “i” and “j” [m]

Aᵢⱼ—normal area between any two nodes, “i” and “j” [m²]

Kᵢⱼ—effective thermal conductivity between any two nodes, “i” and “j” [W/m-K]

B—Boltzmann's constant (5.67×10⁻⁸ W/m²-K⁴)

εᵢⱼ—emissivity of the radiating surface between any two nodes, “i” and “j”

φᵢⱼ—view factor between any two nodes, “i” and “j”

hᵢⱼ—convective heat transfer coefficient between any two nodes, “i” and “j” [W/m²-K]

Kₐᵢ—assembly effective conductivity [W/m-K]

K_{cond}—assembly interior conductivity [W/m-K]

K_{gas}—thermal conductivity of helium in the range of the assembly temperature and pressure [Unterzuber et al (1980)] (determined as 0.2 W/m-K)

F_{cond}—conduction factor as experimentally determined for the given geometry and materials [Manteuffel & Todreas (1991)] (determined as 2.16)

C_{rad}—radiative coefficient (determined as 0.4 for the BWR assembly under consideration as determined by Manteuffel & Todreas (1991))

d—fuel rod outer diameter (1.3 cm, or 0.013 m)

T—average fuel rod temperature (assumed to be 500° K as initial value)

F_{cond,w}—conduction factor for the wall

f—edge-to-interior heat transfer ratio (taken as 0.4518 for BWR assemblies, as calculated from (8))

w—distance from the centre of the outermost fuel rod to the wall exterior (taken as 0.01618 m for the BWR assemblies)

p—pitch, or the distance between the centers of two fuel rods (taken as 0.01352 m for the BWR assemblies)

C_{rad,w,2}—second wall conduction factor [Manteuffel & Todreas (1991)] (determined as 0.085 for BWR assemblies)

L—assembly interior width [m]

A—assembly area in the inter-section of the interior and the exterior regions [m²]

L_{assembly}—length of the assembly cross-sectional edge (taken as 0.14 m)

F₁₋₂—view factor from surface 1 to 2

F₁₋₃—view factor from surface 1 to 3

$$H = \frac{h}{l} ( h and l as in Figure 5 ( b ) )$$

$$W = \frac{w}{l} ( w and l as in Figure 5 ( b ) )$$

### REFERENCES

1.) P. Kar, G. Danko, J. S. Armijo, M. Misra, D. Bahrami, “Thermal design of an Alternative Boiling Water Reactor Spent nuclear Fuel Package for Yucca Mountain Repository”, Submitted to the Nuclear Technology.
2.) T. A. Buschek, “Multiscale Thermohydrologic Model (MSTHM), ANL-EBS-MD-000049-Rev 0, ICN01 CRWMS M&O Publication (2003).
3.) Appendix A—“Inventory and Characteristics of Spent Nuclear Fuel, High-Level Radioactive Waste, and Other Materials”, DOE/EIS-0250D; Draft Environmental Impact Statement for a Geologic Repository.
4.) D. Bahrami, G. Danko, “Thermal-Hydrologic Model of an Alternate Waste |Package Arrangement for Yucca Mountain”, Submitted to the Journal of Nuclear Technology.
5.) G. Danko, MULTIFLUX Software Documentation, University of Nevada Reno, (2000).
6.) H. Shibazaki, M. Nishimura, N. Takahashi, S. Fujii, I. Maekawa, “A Study of Heat transfer Characteristics for a Horizontal Dry Storage System for LWR Spent Fuel Assemblies”, Heat Transfer-Japan Res., 27 (1998), pg. 284-298.
7.) R. D. Manteufel, N. E. Todreas, “Effective Thermal Conductivity and Edge Conductance Model for a Spent-fuel Assembly”, Heat Transfer and Fluid Flow (Nuclear Technology), 105 (1994), pg. 421-440.
8.) R. E. Canaan, D. E. Klein, “An Experimental Investigation of Natural Convection Heat Transfer within Horizontal Spent-fuel Assemblies”, Nuclear Fuel Cycles (Nuclear Technology), 116 (1996), pg. 306-316.
9.) M. Keyhani, V. Prasad, R. Cox, “Experimental Study of Natural Convection in a Vertical Cavity with Discrete Heat Sources”, Journal of Heat Transfer, Transactions ASME, 110, 3 (1988), pg. 616-624.
10.) M. A. Gotovsky, E. D. Fedorovich, V. N. Fromzel, V. A. Shleifer, “Heat Transfer of Rod in Closed Volume Filled with Gas”, Heat Exchange in Atomic Power Plants Energy Equipment, 76 (1986).
11.) R. D. Manteufel, N. E. Todreas, “Analytic Formulae for the Effective Conductivity for a Square or Hexagonal Array of Parallel Tubes”, Fundamental Problems in Conduction Heat Transfer, HTD-207, (1992).
12.) M. Keyhani, L. Luo, “Numerical Study of Convection Heat Transfer Within Enclosed Horizontal Rod Bundles”, Nuclear Science and Engineering, 119 (1995), pg. 116-127.
13.) K. M. Kelkar, S. V. Patankar, “Numerical Prediction of Natural Convection in Square Partitioned Enclosures”, Numerical Heat Transfer, Part A, 17 (1990), pg. 269-285.
14.) R. Unterzuber, R. D. Milines, B. A. Marinkovich, G. N. Kubancsek, “Spent-fuel Dry Storage Testing at E-MAD (March 1978 Through March 1982)”, PNL-4533, Pacific Northwest Laboratory (1982).
15.) R. D. Manteufel, N. E. Todreas, “Heat Transfer in an Enclosed Rod Array”, MITNE-292, Department of Nuclear Engineering, Massachusetts Institute of Technology (1991).
16.) Handbook of Essential Formulae and Data on Heat Transfer for Engineers, Longman (1997), H. Y. Wong.

17.) “Controlled Design Assumptions Document”, B00000000-01717-4600-00032 REV 05, ICN 0, Las Vegas, Nev., CRWMS M&O, ACC: MOL.19980804.0481

TABLE 1
DOE HLW disposal details regarding the
volume and the number of canisters

| | | Volume | |
|---|---|---|---|
| | | of HLW | # of |
| | | (m³) | Canisters |
| Currently existing HLW for disposal in 5 DOE- | | 22000 | 22000 |
| HLW/1 SNF waste packages | | | |
| Co-disposal of DOE- | HLW remaining for | 10037 | 6509 |
| HLW with SNF after | disposal | | |
| enlarging the DOE- | HLW that can be | 11963 | 10108 |
| HLW canisters' | disposed | | |
| diameter to 0.8 m^{a}, | | | |
| and accommodating 1 | | | |
| canister per package | | | |
| Co-disposal of DOE- | HLW remaining for | 0 | 7400 |
| HLW with SNF | disposal | | |
| keeping the DOE- | HLW that can be | 22000 | 7400 |
| HLW the same and | disposed | | |
| accommodating 3 | | | |
| canisters per package | | | |

a—Enlargement of the DOE—HLW canisters' diameter to 0.8 m for accommodation in the co-disposal 44 BWR/1 DOE-HLW packages as shown in FIG. 2. The canisters for the 24 PWR/1 DOE-HLW packages are not enlarged (i.e. kept the same as the License Application design).

What is claimed is:

1. A nuclear material disposal package comprising an enclosure, a nuclear material sub-container container of a first type centrally disposed in the enclosure, a plurality of nuclear material sub-containers of a second type disposed around the nuclear material sub-container of a first type.

2. The nuclear material disposal package of claim 1, wherein the plurality of nuclear material sub-containers of a second are disposed concentrically around the nuclear material sub-container of a first type.

3. The nuclear material disposal package of claim 1, wherein the nuclear material sub-container of a first type is one of a plurality of nuclear material sub-containers of a first type centrally disposed in the enclosure.

4. The nuclear material disposal package of claim 3, wherein the plurality of nuclear material sub-containers of a second type are disposed concentrically around the plurality of nuclear material sub-containers of a first type.

5. The nuclear material disposal package of 1 wherein the nuclear material sub-container of a first type is physically separated from the plurality of nuclear material sub-containers of a second type.

6. The nuclear material disposal package of claim 1, wherein the nuclear material sub-container of a first type is separated from the plurality of nuclear amteiral sub-containers of a second type by a stainless steel layer.

7. The nuclear material disposal package of claim 1, wherein each of the plurality of nuclear material sub-containers of a second type are disposed in a basket at least partially comprises a neutron blocking material.

8. The nuclear material disposal package of claim 7, wherein the neutron blocking material comprises Neutronit.

9. The nuclear material disposal package of claim 7, wherein the basket at least partially comprises aluminum.

10. The nuclear material disposal package of claim 1, wherein each of the plurality of nuclear material sub-containers of a second type are disposed in a basket at least partially comprises aluminum.

11. The nuclear material disposal package of claim 1, wherein the number of the plurality of nuclear material sub-containers of a second type is selected to maintain the temperature of the nuclear material disposal package at less than 350 degrees centigrade.

12. The nuclear material disposal package of claim 1, further comprising an aluminum shunt disposed in the enclosure, whereby the aluminum shunt conducts heat from the interior of the enclosure to the exterior of the enclosure.

13. A drift arrangement comprising a plurality of the nuclear material disposal packages of claim 1.

14. The nuclear material disposal package of claim 1, wherein the nuclear material sub-container of a first type is a high level nuclear waste container and the plurality of nuclear material sub-containers of a second type are boiling water reactor containers or pressurized water reactor containers.

15. A method of storing a greater amount of nuclear material in an area comprising placing a plurality of the nuclear material disposal packages of claim 1 in an emplacement drift.

16. The nuclear material disposal package of claim 1, wherein the nuclear material sub-container of a first type is separated from the plurality of nuclear material sub-containers of a second type by an inert gas.

17. The nuclear material disposal package of claim 1, wherein forty-four nuclear material sub-containers of a second type are disposed around the nuclear material sub-container of a first type.

18. The nuclear material disposal package of claim 1, wherein twenty-four nuclear material sub-containers of a second type are disposed around the nuclear material sub-container of a first type.

19. The nuclear material disposal package of claim 1, wherein the nuclear material sub-container of a first type is one of three nuclear material sub-containers of a first type and the plurality of nuclear material sub-containers of a second type are fifty-five waste nuclear material sub-containers of a second type disposed around the three nuclear material sub-containers of a first type.

20. The nuclear material disposal package of claim 1, wherein the nuclear material sub-container of a first type is one of three nuclear material sub-containers of a first type and the plurality of nuclear material sub-containers of a second type are eighteen nuclear material sub-containers of a second type disposed around the three nuclear material sub-containers of a first type.
